(19) United States
(12) Patent Application Publication
(10) Pub. No.: US 2020/0305384 A1
(43) Pub. Date: Oct. 1, 2020

(54) Easy-to-clean litter receptacle assembly: bowl, scatter guard, scoop

(71) Applicant: Thomas Prichard Ray Christian, Kirbyville, MO (US)

(72) Inventor: Thomas Prichard Ray Christian, Kirbyville, MO (US)

(21) Appl. No.: 16/501,368

(22) Filed: Apr. 1, 2019

(51) Int. Cl. A01K 1/01

(52) U.S. Cl. CPC A01K 1/011

(57) ABSTRACT

A litter receptacle assembly including a litter bowl with a concave curved interior surface, a litter bowl scoop with a convex curved leading-edge surface and a convex curved underside surface, both of which have an identical radius of curvature as that of the concave curved interior surface of the litter bowl, and a litter bowl scatter guard with reduced inner diameter of the lower ledge rim relative to inner diameter of the upper ledge rim of the litter bowl's concave curved interior surface.

### PRIORITY CLAIM

None

### TECHNICAL FIELD

This invention relates in general to pet litter receptacles, specifically to a litter bowl, litter bowl scatter guard, and litter bowl scoop with vastly improved geometry to facilitate the efficient removal of waste from litter.

### BACKRGOUND OF THE INVENTION

Indoor-pet owners who have trained their quadruped companions to empty their bladders and evacuate their bowels into a device containing a particulate known commonly as “litter” have long-suffered the inability to easily and properly, clean and maintain such a device due to inherent design flaws of the common litter box and common litter scoop.

Common litter boxes are quadrilateral devices that all have an inherent design flaw, flat bottoms with vertical sides that create corners. Each corner creates a two- or six-sided surface of which urine will adhere. Even circular shaped devices suffer the same fatal design flaw because even though they feature constant-curvature vertical sidewalls they also feature flat bottoms creating a constant corner. Each urine deposit that adheres to a corner inevitably is destroyed in the removal process. To further exacerbate the problem the common litter scoop is not designed to function with the common litter box regardless of the receptacle's ultimate shape, length, width, height, ETC. One has to dig and scrape at the urine clump in an attempt to remove it without compromising the clump's integrity. Once the integrity of the bound urine clump or fecal waste is compromised and said clump has crumbled to tiny pieces small enough to slip though the sifter of a common litter scoop it becomes impractical to remove them, thus, effectively diminishing the usable life of the litter to the point that the litter becomes unsanitary and useless. At this point the entire contents of a litter box must be discarded.

Numerous attempts have been made to solve the problem. Automated mechanical cleaning devices such as U.S. Pat. No. 8,381,687 B2 were meant to make cleaning the litter box easier by cleaning themselves. One of the many critical flaws in this concept is that the entire rake mechanism must be removed and cleaned separately in order to properly clean and sanitize the devise. Another flaw is that the mechanical rake cannot discern coherence of a urine clump and therefore through the mechanical force of the rake it inevitably destroys the urine clump rendering the litter unsanitary and unusable. The mechanical rake also cannot discern fecal clump along the sidewall creating an even more difficult mess to clean. Also, the mechanical rake can be inadvertently cycled while in use by the animal which can cause the unsuspecting pet to become leery of the devise therefore causing the pet to urinate and defecate outside the devise, or to avoid using it all together.

Complicated multi-piece sifting devices meant to lift and separate the waste from the litter such as U.S. Pat. No. 8,375,895 B2 are cumbersome and clumsy and require a great deal more effort to properly clean and sanitize them rendering them impractical for the average time-strapped pet owner. And, it is disingenuous to claim no scoop is needed to clean these sifting-type litter receptacles, anyone who has ever cleaned a litter box knows that urine and feces will inevitably adhere to a sidewall that no amounting of sifting will dislodge.

“Corner-less” devices such as US D636,545 S, US D678,623 S, and US D646,444 S all have failed to solve this vexing problem, too. They all have flat bottoms and vertical walls with varying degrees of corners, and scoops that were never intended to function as one with the receptacle. Even circular-sector shaped devices such as US D725,319 S, meant to be placed in the corner of a room, have flat bottoms and vertical sides and corners with scoops ill equipped to properly clean the litter.

Consequently, there is a real need for a pet litter receptacle with vastly improved geometry that is more efficient, more sanitary, easier to use, and less expensive to own and maintain.

It is the intent of this invention to finally resolve these common problems.

### SUMMARY OF THE DISCLOSURE

A litter receptacle assembly comprising a litter bowl, litter bowl scatter guard, and litter bowl scoop allowing for one to finally maintain an inviting, unspoiled, safe and sanitary destination for their feline, or other litter-trainable companion to relieve themselves. The unique feature that really makes this invention different from all other litter receptacles is the concave curved interior surface of the litter bowl and the convex curved surfaces of the leading edge and underside of the litter bowl scoop share an identical radius of curvature, wherein when the user pushes the litter bowl scoop through the litter the convex leading-edge surface of the litter bowl scoop makes complete contact with the concave curved interior surface of the litter bowl, regardless of placement in the litter bowl, allowing the user to effectively and efficiently remove urine clumps and fecal waste without destroying the integrity of said clumps, increasing indefinitely the usable lifespan of the litter. A litter bowl scatter guard with a vertical sidewall that rests atop the upper ledge of the litter bowl to prevent litter from being ejected, a litter bowl scatter guard with reduced inner diameter of lower rim relative to inner diameter of the upper ledge rim of the litter bowl's interior to prevent urine or feces from being excreted at the very edge of the litter bowl's interior in the shallow litter, a litter bowl scatter guard that stows inside the bottom of the litter bowl for low-cost shipping and space-saving storage.

### BRIEF DESCRIPTION OF THE DISCLOSURE

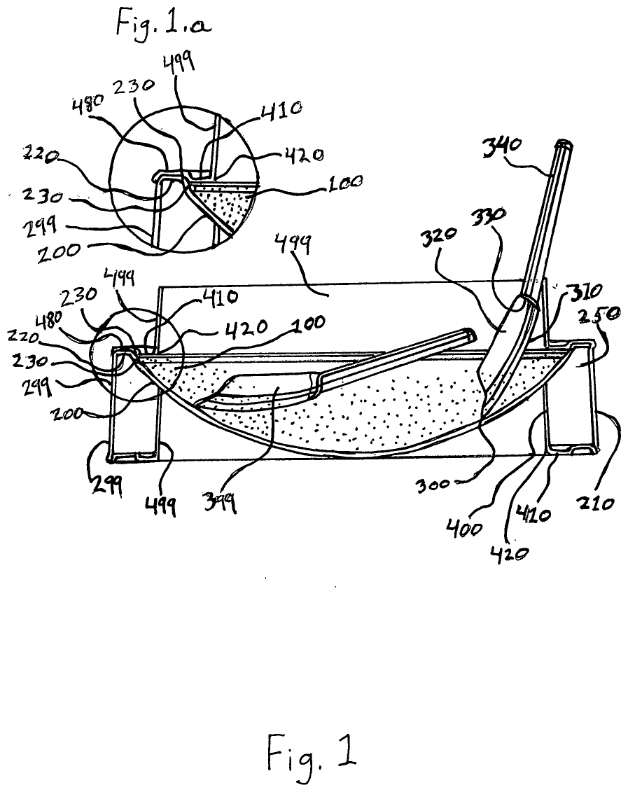

FIG. 1 is a sectioned side-view assembly of a single functioning litter receptacle system comprising a litter bowl, litter bowl scatter guard, and litter bowl scoop depicting the matching radius of curvature of the concave curved interior surface of the litter bowl and the convex curved surfaces of the leading-edge and underside of the litter scoop, depicting a scatter guard with a vertical sidewall to prevent litter from being ejected from the litter bowl, depicting how the litter bowl scatter guard rests atop the litter bowl during regular use, depicting how the litter bowl scatter guard is stowed in the underside of the litter bowl for shipping and storage, depicting how the I.D. of the lower rim of the litter bowl scatter guard is reduced relative to the I.D. of the upper rim of the interior of the litter bowl to prevent the user from urinating in the shallow litter at the outer edge of the litter bowl's interior thus preventing the urine from adhering directly to the naked surface of the litter bowl's concave curved interior surface.

FIG. 1.a is an enlarged view of the reduced I.D. of the lower rim of the litter bowl scatter guard relative to the I.D. of the upper rim of the interior of the litter bowl to prevent the user from urinating in the shallow litter at the outer edge of the litter bowl interior thus preventing the urine from adhering directly to the naked surface of the litter bowl's concave curved interior surface.

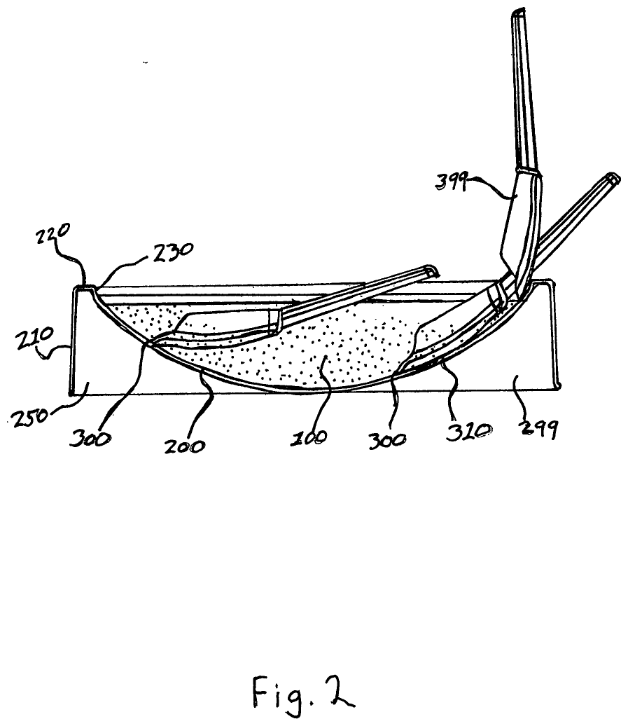

FIG. 2 is a sectioned side-oriented view of the litter bowl of FIG. 1 and a side view of the litter bowl scoop of FIG. 1 depicting the litter bowl scoop passing through a particulate commonly known as litter, depicting the identical radius of curvature of the concave curved interior surface of the litter bowl and the convex curved surfaces of the leading-edge and underside of the litter bowl scoop.

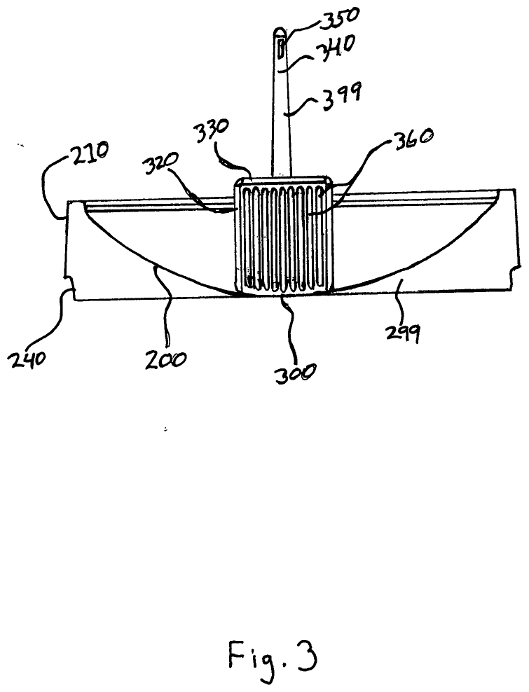

FIG. 3 is a sectioned side-oriented view of the litter bowl of FIG. 1 and a top view of the litter bowl scoop of FIG. 1 depicting the concave curved interior surface of the litter bowl and the identical radius of curvature of the convex curved surface of the leading-edge of the litter scoop.

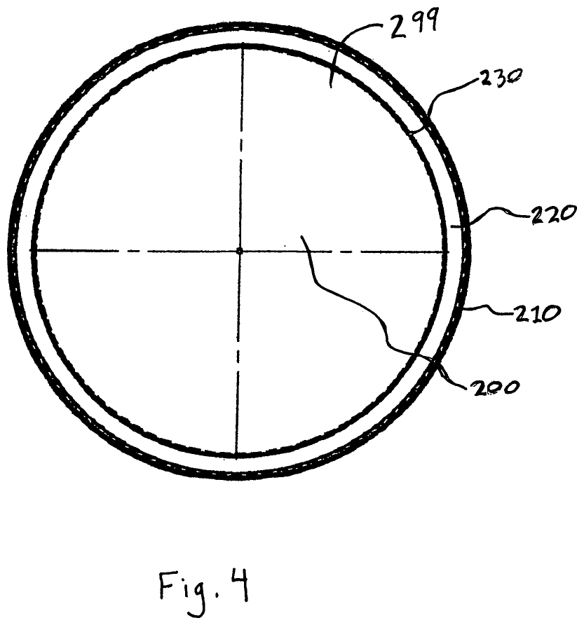

FIG. 4 is top-oriented view of the litter bowl of FIG. 1 depicting the litter bowl's concave curved interior surface.

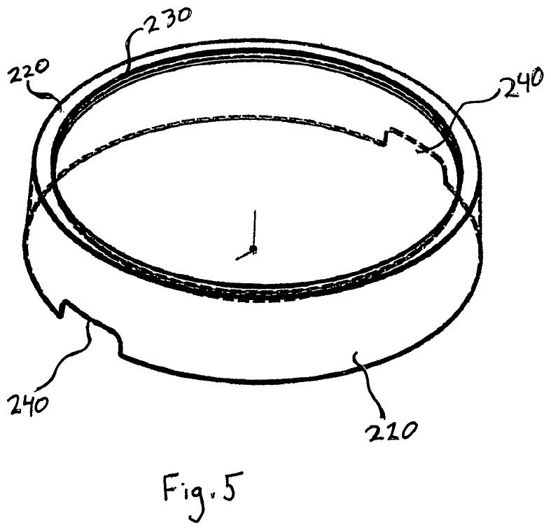

FIG. 5 is a rotated angled top-oriented view of the litter bowl of FIG. 1 depicting the litter bowl's cut-outs as handles at the bottom of the vertical sidewall.

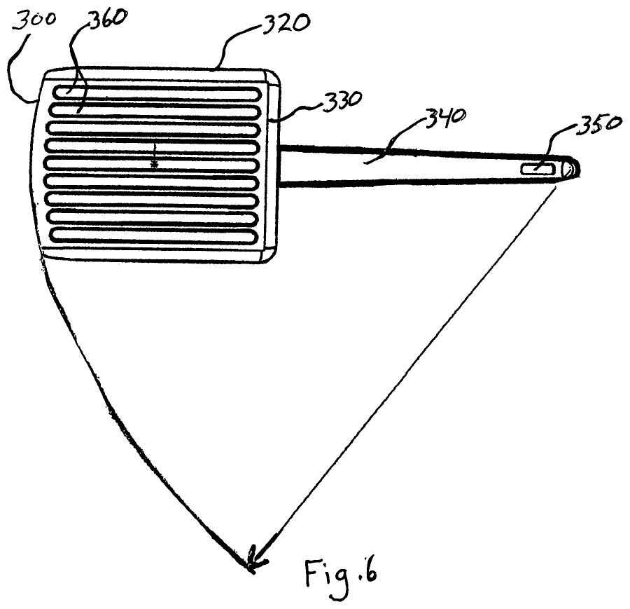

FIG. 6 is a top-oriented view of the litter bowl scoop of FIG. 1 depicting the litter bowl scoop's convex curved leading-edge surface and a plurality of elongated slots.

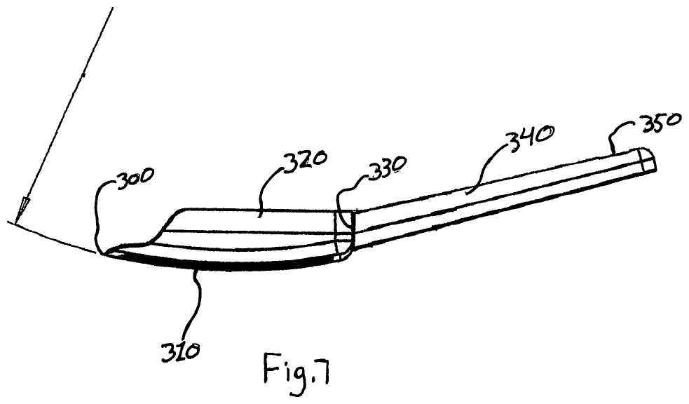

FIG. 7 is a side-oriented view of the litter bowl scoop of FIG. 1 depicting the convex curved surfaces of the leading-edge and underside of the litter bowl scoop.

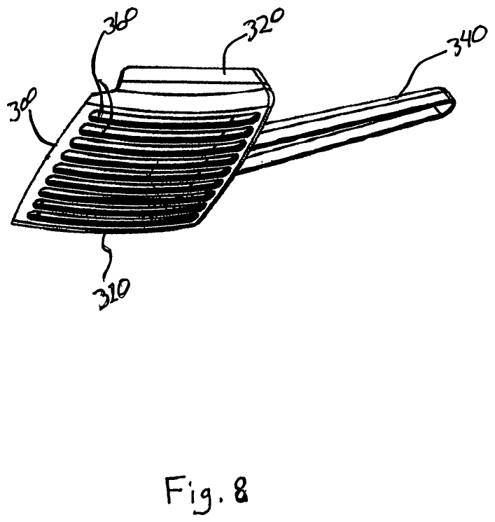

FIG. 8 is a rotated bottom-oriented view of the litter bowl scoop of FIG. 1 depicting the convex curved surfaces of the leading-edge and underside of the litter bowl scoop, depicting a plurality of elongated slots.

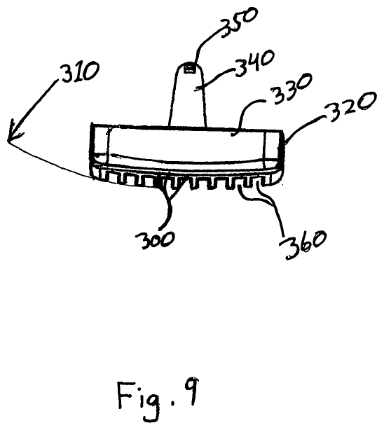

FIG. 9 is a front-oriented view of the litter bowl scoop of FIG. 1 depicting the convex curved surfaces of the leading-edge and underside of the litter bowl scoop.

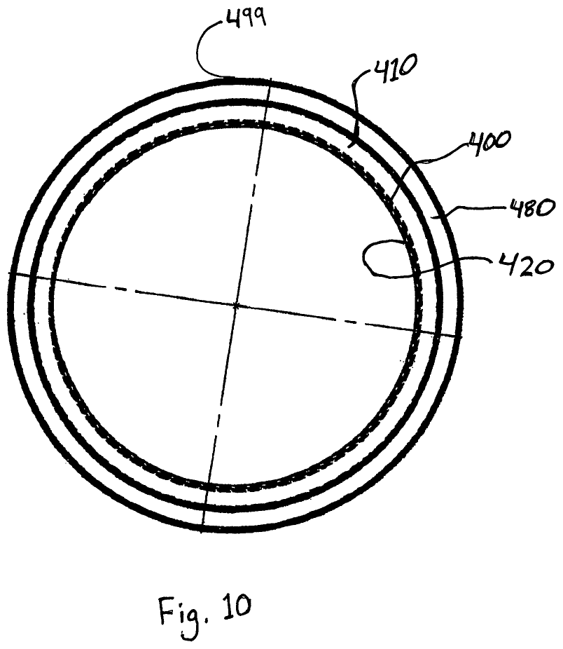

FIG. 10 is a top-oriented view of the litter bowl scatter guard of FIG. 1 depicting a vertical sidewall to prevent litter from being ejected from the litter bowl, depicting a lower ledge rim with a reduced I.D. relative to the upper ledge rim I.D. of the interior of the litter bowl.

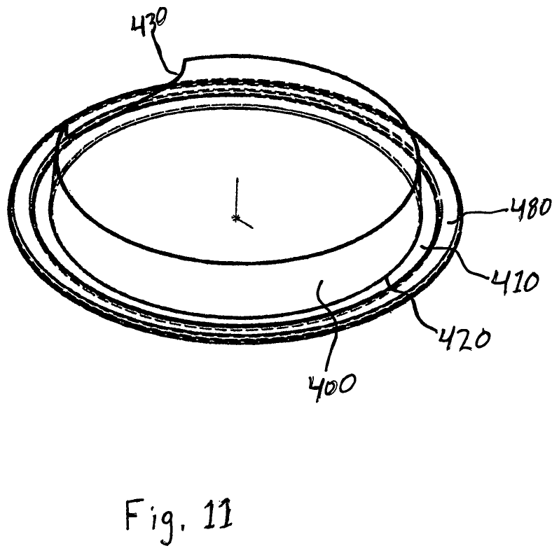

FIG. 11 is a rotated top-oriented view of the litter bowl scatter guard of FIG. 1 depicting a vertical sidewall to prevent litter from being ejected from the litter bowl, depicting a semi-circular cutout on the sidewall to allow easy ingress for the user.

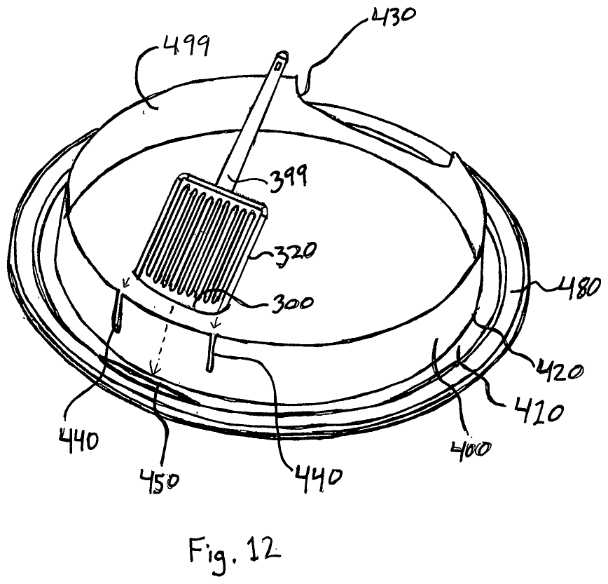

FIG. 12 is a top-oriented rotated view of a second embodiment of the litter bowl scatter guard of the present disclosure of FIG. 1 depicting a slotted vertical sidewall litter bowl scoop holder, depicting a semi-circular cutout on the sidewall allowing for easy ingress of the user.

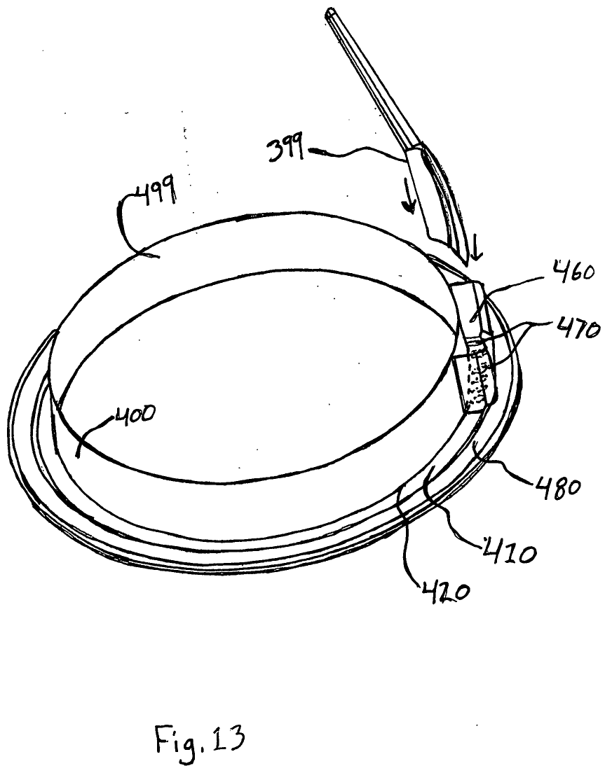

FIG. 13 is a rotated top-oriented view of a third embodiment of the present disclosure of the litter bowl scatter guard of FIG. 1 depicting a vertical sidewall to prevent litter from being ejected from the litter bowl, depicting a pocketed litter bowl scoop holder on the sidewall, depicting no cutout on the sidewall.

### LEGEND

100 Particulate known commonly as litter.

200 Concave curved interior surface of litter bowl.

210 Vertical sidewall with draft of litter bowl.

220 Upper ledge of litter bowl

230 Inner diameter of rim of litter bowl—start of concave curved interior surface.

240 Sidewall cut out for use as handles of litter bowl.

250 Open underside of litter bowl.

299 Litter bowl.

300 Convex curved surface of the leading-edge of the litter bowl scoop.

310 Convex curved surface of the underside of the litter bowl scoop.

320 Vertical sidewall of litter bowl scoop.

330 Vertical backwall of litter bowl scoop.

340 Handle of litter bowl scoop.

350 Hole in handle of litter bowl scoop.

360 Plurality of elongated slots in the bottom portion of the litter bowl scoop.

399 Litter bowl scoop.

400 Vertical sidewall with draft of litter bowl scatter guard.

410 Lower ledge of litter bowl scatter guard.

420 Inner diameter of rim of lower ledge of litter bowl scatter guard.

430 Semi-circular cut out of sidewall of litter bowl scatter guard.

440 Slotted sidewall of litter bowl scatter guard.

450 Slotted lower ledge of litter bowl scatter guard.

460 Sidewall of litter bowl scoop pocket at sidewall of litter bowl scatter guard.

470 Plurality of elongated slots in lower ledge of litter bowl scatter guard.

480 Upper ledge of litter bowl scatter guard.

499 Litter bowl scatter guard.

### DETAILED DESCRIPTION OF THE DISCLOSURE

Reference will now be made in detail to embodiments of this disclosure, examples of which are illustrated in the accompanying drawings. Wherever possible, the same reference numbers will be used throughout the drawings to refer to the same or like parts.

This disclosure describes in detail a litter receptacle assembly comprising a litter bowl, litter bowl scatter guard, and litter bowl scoop allowing for one to finally maintain an inviting, unspoiled, safe and sanitary destination for their feline, or other litter-trainable companion to relieve themselves. A litter bowl with a concave curved interior surface and a litter bowl scoop with convex curved surfaces with the identical radius of curvature (of the concave curved interior surface of the litter bowl) on the leading-edge and underside of the scoop wherein when the user pushes the litter bowl scoop through the litter the convex leading-edge surface of the litter bowl scoop makes complete contact with the concave curved interior surface of the litter bowl, regardless of placement in the litter bowl, allowing the user to effectively and efficiently remove urine clumps and fecal waste without destroying the integrity of said clumps, increasing indefinitely the usable lifespan of the litter. A litter bowl scatter guard with a vertical sidewall that rests atop the rim of the litter bowl to prevent litter from being ejected, a litter bowl scatter guard with reduced inner diameter of lower rim relative to inner diameter of the upper ledge rim of the litter bowl's concave curved interior surface to prevent urine or feces from being excreted at the very edge of the litter bowl's concave curved interior surface in the shallow litter, a litter bowl scatter guard that stows in the hollow underside of the litter bowl for low-cost shipping and space-saving storage.

FIG. 1, a litter receptacle assembly according to the first embodiment of the present disclosure is illustrated. A litter bowl 299 of the first embodiment that includes a concave curved interior surface 200 to hold litter 100 and the like, a vertical sidewall 210 with draft to allow for plastic injection mold release and nest-ability, an upper ledge portion 220 of the litter bowl 299 of which the upper ledge portion 480 of the 499 litter bowl scatter guard of the first embodiment, with a vertical side wall 400 with draft to allow for plastic injection mold release and nest-ability, rests atop of to prevent litter 100 from being ejected, an open underside portion 250 of the litter bowl 299 that stows the litter bowl scatter guard 499 during shipping and storage. A litter bowl scatter guard 499 of the first embodiment with a lower ledge 410 with a reduced inner diameter 420 relative to the upper ledge 220 inner diameter 230 of the litter bowl 299. A litter bowl scoop 399 of the first embodiment with a handle portion 340, a side-wall portion 320, and a convex curved leading-edge surface 300 with an identical radius of curvature of the concave curved interior surface 200 of the litter bowl 299 and a convex curved underside surface 310 with an identical radius of curvature of the concave curved interior surface 200 of the litter bowl 299 so that when the litter bowl scoop 399 is pushed through the litter 100 the convex curved leading surface 300 makes complete contact with the litter bowl's 299 concave curved interior surface 200 throughout the entire scooping motion and the convex curved underside surface 310 makes at least partial contact with the litter bowl's 299 concave curved interior surface 200 throughout the entire scooping motion.

FIG. 1.a, a zoomed-in view of FIG. 1 of the litter bowl scatter guard's 499 lower ledge 410 inner diameter 420 with a reduced radius relative to the litter bowl's 299 upper ledge 220 inner diameter 230 preventing urine and feces from being excreted in the shallow litter 100 at the outer perimeter of the litter bowl's 299 concave curved interior surface 200.

FIG. 2, a litter bowl scoop 399 of FIG. 1 passing through litter 100 where-in the convex curved leading-edge surface 300 makes complete contact, and convex curved underside surface 310 makes at least partial contact, with the litter bowl's 299 concave curved interior surface 200 because these three components share a single radius of curvature. This sharing of a radius of curvature is what makes the litter bowl assembly a unique design. It is the ability to place the litter bowl scoop 399 anywhere in the litter bowl 299 and have the leading-edge surface 300 of the litter bowl scoop 399 make complete contact with the concave interior surface 200 of the litter bowl 299 therefore ensuring any waste is removed completely.

FIG. 3, a litter bowl scoop 399 of FIG. 1 standing vertically in a litter bowl 299 of FIG. 1 depicting a litter bowl scoop 399 with a convex curved leading-edge surface 300 with an identical radius of curvature as the litter bowl's 299 concave curved interior surface 200.

FIGS. 4, 5, a litter bowl 299 of FIG. 1 with a concave curved interior surface 200, an upper ledge portion 220 with an inner diameter 230, and a vertical side wall with draft 210.

FIGS. 6-9, a litter bowl scoop 399 of FIG. 1 with a convex curved leading-edge surface 300, a hole 350 in the handle portion 340 for hanging in a retail or home setting, a vertical back wall portion 330, a vertical side wall portion 320, a plurality of elongated slots 360 that allow litter to pass through leaving only the urine clumps and fecal waste to be disposed of.

FIGS. 10, 11, a litter bowl scatter guard 499 of FIG. 1 with an upper ledge surface 480 that when installed on the litter bowl 299 of FIG. 1 rests atop the litter bowl's 299 upper ledge 220, a lower ledge rim surface 410 with a reduced inner diameter 420 relative to the litter bowl's 299 upper ledge 220 inner diameter 230 thus preventing the user from urinating or defecating in the shallow litter 100 at the outer most edge of the litter bowl's 299 concave curved interior surface 200 thus preventing urine and fecal waste from adhering to the concave curved interior surface 200.

FIG. 12, a second embodiment litter bowl scatter guard 499 of FIG. 1 with a vertical side wall with draft 400 to allow for ease of release in a plastic injection mold manufacturing process and to also allow for nest-ability during shipping and storage, with a semi-circular cut-out 430 for ease of access for the user, with a upper ledge surface 480 that when installed on the litter bowl 299 rests atop the litter bowl's 299 upper ledge 220, a lower ledge rim surface 410 with a reduced inner diameter 420 relative to the litter bowl's 299 upper ledge 220 inner diameter230 and slotted sidewall 440 and slotted lower ledge 450 for use as a litter bowl scoop holder 399.

FIG. 13, a third embodiment litter bowl scatter guard 499 with a vertical side wall with draft 400 to allow for ease of release in a plastic injection mold process, with a upper ledge surface 480 that when installed on the litter bowl 299 rests atop the litter bowl's 299 upper ledge 220, a lower ledge rim surface 410 with a reduced inner diameter 420 relative to the litter bowl's 299 upper ledge 220 inner diameter 230, a litter bowl scoop holder460, or pocket with a plurality of elongated slots 470 in the lower ledge 410 to allow for litter 100 to fall back into the litter bowl 299 after use.

### INDUSTRIAL APPLICABILITY OF THE DISCLOSURE

In practice, a litter bowl, litter bowl scatter guard, and litter bowl scoop may be manufactured, bought or sold, or otherwise obtained according to any of the embodiments described herein. In some instances, the litter bowl, litter bowl scatter guard, or litter bowl scoop may be sold separately as replacement parts.

The components described herein, including the litter bowl, litter bowl scatter guard, and litter bowl scoop may be made using a plastic injection molding process. The components may be molded of any suitable thermoplastic material that is easily molded that can provide the end properties needed for any particular application.

The components described herein, including the litter bowl, litter bowl scatter guard, and litter bowl scoop may be made using a metal stamping process. The components may be stamped of any suitable metal, aluminum, or steel alloy that can provide the end properties needed for any particular application.

It will be apparent to those skilled in the art that various modifications and variations can be made to the embodiments of the apparatus and methods of assembly as discussed herein without departing from the scope or spirit of the invention. Other embodiments of this disclosure will be apparent to those skilled in the art from consideration of the specification and practice of the various embodiments disclosed herein. For example, some of the equipment may be constructed and function differently than what has been described herein and certain steps may be omitted, performed in an order that is different than what has been specifically mentioned or in some cases performed simultaneously or in sub-steps. Furthermore, variations or modifications, to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

That which is claimed:

1. A litter receptacle assembly comprising: A litter bowl with a concave curved interior surface, and a litter bowl scoop with a convex curved leading-edge surface and a convex curved underside surface both of which have an identical radius of curvature as that of the concave curved interior surface of the litter bowl; and a litter bowl scatter guard with reduced inner diameter of the lower ledge rim relative to inner diameter of the upper ledge rim of the litter bowl's concave curved interior surface.

2. The litter receptacle assembly of claim 1 wherein the litter bowl scatter guard stows inside the bottom of the litter bowl.

3. The litter receptacle assembly of claim 1 wherein the litter bowl scatter guard has a slotted sidewall and a slotted lower ledge wherein the sidewalls of the litter bowl scoop would fit into the slotted sidewall of the litter bowl scatter guard and the leading-edge surface of litter bowl scoop would fit into the slotted lower ledge of the litter bowl scatter guard effectively creating a litter bowl scoop holder.

4. The litter receptacle assembly of claim 1 wherein the litter bowl scatter guard has a three-walled pocket effectively creating a litter bowl scoop holder.
